(19) United States
(12) Patent Application Publication
(10) Pub. No.: US 2007/0299218 A1
(43) Pub. Date: Dec. 27, 2007

(54) SOLDER-RESISTANT FLEXIBLE THERMOSETTING EPOXY RESIN SYSTEM

(76) Inventors: Syh-Tau Yeh, Taoyuan County (TW); Yao-Ming Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/425,718

(22) Filed: Jun. 22, 2006

(51) Int. Cl. C08G 59/00; B60C 1/00; C08G 67/02; C08G 59/14

(52) U.S. Cl. 525/524; 524/492; 524/612; 528/403

(57) ABSTRACT

A thermosetting epoxy resin composition with improved flexibility, adhesion and solder resistance includes (a) 40-100 phr (parts per hundred parts) of dimmer acid modified epoxy resin; (b) 0-60 phr of an additive epoxy resin for adjusting softness; (c) 1-30 phr of a hardening agent; and (d) 0.1-10 phr of a catalyst.

### BACKGROUND OF THE INVENTION

1. Field of the Invention

The present invention relates generally to the field of electronic materials. More particularly, the present invention relates to composition of a dimmer-acid modified epoxy resin system. The dimmer-acid modified epoxy resin film formed according to the recipe of the present invention exhibits superior flexibility, chemical resistance, and solder resistance, which is particularly suited for electronic applications such as packaging, substrate bonding, among others.

2. Description of the Prior Art

Conventionally, assembling of electronic products uses soldering techniques to fix electronic components onto a surface of a printed circuit board (PCB). When soldering, the temperature is very high, typically 240° C.-290° C., and such high temperature, even the operating time is short, can damage the organic resin portion of the PCB. If the heat resistance of the organic resin portion of the PCB is insufficient, peeling at the bonding interface occurs, causing reliability problem of the electronic products. The poor interface bonding is also prone to moisture attacks. To avoid this, the resin portion must provide good adhesive property such that the resin can tightly adhere to the copper foil.

There are several factors that are usually taken into consideration when selecting suitable resin materials for PCB, they are heat resistance (or solder resistance, or solder heat resistance), chemical resistance, adhesion ability, and cost. However, it is difficult to find a resin material that possesses all these properties and meets all these requirements.

By far, epoxy resins may be arguably the most commercially acceptable resin material for PCB applications although it merely meets some of the basic requirements previously mentioned above. However, the prior art epoxy resin has several drawbacks. For example, the prior art epoxy resin is fragile, thus is not suitable for flexible PCB applications where the resin film has to be flexible. Therefore, the flexible PCB typically uses costly polyimide (Pl) films as its major dielectric layer. Unfortunately, the Pl film has poor adhesion to the copper foil.

To remedy this, it is necessary to use bonding agent, for example, acrylonitrile butadiene rubber (NBR)-modified epoxy resin, between the copper foil and the Pl film, thereby forming so-called adhesive-type or three-layer flexible substrate. However, it becomes problematic when the weight of the NBR-modified epoxy resin becomes too high or too low. When the weight of the NBR-modified epoxy resin is low, the flexibility of the substrate becomes insufficient. When it is too high, the heat resistance of the substrate is reduced.

For example, U.S. Pat. No. 5,260,130 filed Mar. 26, 1992 to Sakaguchi et al. discloses a coverlay film, which is used for protection of a flexible printed circuit board, with improved adhesiveness, heat-resistance against molten solder alloy. The coverlay film forms an adhesive on a polyimide substrate. The adhesive is formulated with an epoxy resin, carboxylated nitrile rubber, curing agent for the epoxy resin, curing accelerator and fine inorganic powder each of a specified type and in a specified weight proportion.

U.S. Pat. No. 4,465,542 filed Feb. 17, 1983 to Furihata teaches an adhesive composition containing: (a) a nitrogen atom-free epoxy compound, (b) a poly N-glycidyl type epoxy resin, (c) a nitrile rubber having a carboxyl group, and optionally (d) a finely divided silica, a clay substance treated with an onium compound, or a mixture thereof. This adhesive composition has excellent adhesion strength, soldering heat resistance, flexibility, and chemical resistance, and has a small resin flow property.

In some cases, the acrylic resins are used as the bonding agent in manufacture of flexible PCB. For example, U.S. Pat. No. 4,762,747 filed Jul. 29, 1986 to Liu et al. discloses an adhesive composition useful for bonding metal foils to polyimide films. The composition consists of water and a homogeneous film-forming acrylic polymer. The acrylic polymer is a polymerization product of (A) acrylonitrile or methacrylonitrile, or mixture thereof, (B) an alkyl acrylate or methacrylate having 1-12 carbon atoms in the alkyl group, or mixture thereof, (C) an oxirane-containing polymerizing ethylenic monomer and (D) a hydroxyl- or amide-containing acrylate or methacrylate.

However, the acrylic resins are prone to moisture absorption. Besides, the electrical insulation ability of such acrylic resins is an issue when applied to circuit design where denser pitches, high heat resistance and low moisture absorption are required.

U.S. application Ser. No. 2001/0018122 A1 filed Jan. 17, 2001 to Yuyama et al. teaches an epoxy resin-based adhesive composition, which is particularly suitable for use in the preparation of a base sheet for flexible printed circuit boards as a laminate of an insulating plastic resin film and a foil of a metal such as copper as well as in the preparation of a coverlay film for protection of the circuit pattern of the metal foil in a flexible printed circuit board. The adhesive composition comprises, as a uniform blend, (a) an epoxy resin, (b) an acrylic rubber modified by carboxyl groups to have a specified content of the carboxyl groups, (c) a curing agent for the epoxy resin such as an aromatic amine compound and (d) a curing promoter, each in a specified weight proportion.

It is desired to provide an improved resin film that has better properties including better flexibility, more superior adhesion ability, heat resistance, chemical resistance and lower moisture absorption than any of the above-mentioned prior art resin adhesives or coverlay films.

### SUMMARY OF THE INVENTION

It is one object of this invention to provide a composition of a dimmer-acid modified epoxy resin system. The dimmer-acid modified epoxy resin film formed according to the recipe of the present invention exhibits superior flexibility, chemical resistance, and solder resistance, which is particularly suited for electronic applications such as packaging and substrate bonding.

According to the claimed invention, a thermosetting epoxy resin composition with improved flexibility, adhesion and solder resistance is disclosed, whcih comprises:

(a) 40-100 phr (parts per hundred parts) of dimmer acid modified epoxy resin;

(b) 0-60 phr of an additive epoxy resin for adjusting softness;

(c) 1-30 phr of a hardening agent; and

(d) 0.1-10 phr of a catalyst.

The dimmer acid modified epoxy resin comprises Dimer Acid modified DGEBA, Dimer Acid Adducted to an Epoxidized Bisphenol A Resin, and Dimer Acid Glycidyl Ester. The additive epoxy resin comprises Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber. The hardening agent comprises dicyandiamide, phenol-formaldehyde resins, melamine-formaldehyde resins, polyamides, polysulfides, amidoamines, and aromatic amines. The catalyst comprises amines, imidazoles, and BF3-MEA.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 lists the experiment results (Exp. 1˜Exp. 3) based on dimmer acid modified epoxy resin having different compositions; and

FIG. 2 lists the experiment results (Exp. 4˜Exp. 6) based on dimmer acid modified epoxy resin having different compositions (mainly different hardening agents).

### DETAILED DESCRIPTION

The present invention pertains to the field of electronic materials. More particularly, the present invention provides a composition of a dimmer-acid modified thermosetting epoxy resin system and a novel thermosetting epoxy resin film prepared by using such composition. The dimmer-acid modified thermosetting epoxy resin film formed according to the recipe of the present invention exhibits superior flexibility, chemical resistance, and solder resistance, which is particularly suited for electronic applications such as packaging, substrate bonding, and so on.

The novel thermosetting epoxy resin film prepared by using the composition of the present invention is applicable to a variety of industry fields, but is particularly suited for flexible PCB industry. For example, the novel thermosetting epoxy resin film prepared by using the composition of the present invention can replace the conventional coverlay and be used to as solder mask for the protection of the surface of the flexible PCB.

Alternatively, the novel thermosetting epoxy resin film prepared by using the composition of the present invention can replace the conventional carboxylterminated butadiene acrylonitrile (CTBN)-modified epoxy resin system and be used as adhesive of a protection film. The novel thermosetting epoxy resin film prepared by using the composition of the present invention can be used as bonding agent for flexible PCB and is applied to interface between layers of the flexible PCB. The novel thermosetting epoxy resin film prepared by using the composition of the present invention can be used as adhesive on a reinforcement film.

The present invention provides a novel composition of a dimmer-acid modified epoxy resin system and dimmer-acid modified epoxy resin film thereof. The dimmer-acid modified epoxy resin film formed according to the recipe of the present invention exhibits superior flexibility, chemical resistance, and solder resistance, which is particularly suited for electronic applications such as packaging, substrate bonding.

After admixing with proper additives and after curing, the dimmer acid modified flexible epoxy resin system exhibits superior flexibility, chemical resistance, and solder resistance. The novel dimmer acid modified flexible epoxy resin is applicable to flexible PCB and used as a protection solder mask with improved flexibility and chemical resistance and reduced cost. The preparation of the novel dimmer acid modified flexible epoxy resin system and its use are also simplified.

The novel dimmer acid modified flexible epoxy resin system can be used as good bonding agent and can be used to bond dielectric layer or bonding layer of either hard board PCB or flexible PCB. The novel dimmer acid modified flexible epoxy resin system has improved adhesion to both copper and polyimide.

Dimer acid (or dimerized fatty acid), which can be dissolved in many kinds of organism, is a kind of duality acid polymer from fatty acid and it is over 2 carboxyl groups. Dimer acid has good heat stability and will not harden at low temperatures. Dimmer-acid is mainly used in polyamide resin synthesis and manufacture, and as fuel oil agent, lubricant agent, etc., and the dimmer-acid modified epoxy resin film exhibits superior flexibility, chemical resistance, and solder resistance.

Examples of commercially available dimmer-acid modified epoxy resin includes but not limited to NPER-172 (Dimer Acid modified DGEBA) available from Nanya Plastics Corp. (NPER-172 is a product name of Nanya Plastics Corp.), HyPox DA323 (Dimer Acid Adducted to an Epoxidized Bisphenol A Resin; CAS No. 67989-52-0) available from CVC Specialty Chemicals Inc., and ERYSYS GS-120 (Dimer Acid Glycidyl Ester; CAS No. 68475-94-5) available from CVC Specialty Chemicals Inc., YD-172 available from Tohto Kasei Co., Ltd., and YD-271 or YD-272 available from Eptec.

In order to adjust the reactivity and/or physical properties, the aforesaid dimmer-acid modified epoxy resins may be employed singly or combined with other types of additive resins. For example, the aforesaid other types of additive resins may be selected from the group consisting of Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber.

To obtain adequate softness, the content of the dimer acid modified thermosetting epoxy resin preferably ranges between 40-100 phr (pars per hundred parts) of total weight of the resin mixture, while the aforesaid additive resin preferably ranges between 60-0 phr of total weight of the resin mixture.

The aforesaid resins may be mixed with proper amount of hardening agent and catalysts. For example, the hardening agent may include dicyandiamide, phenol-formaldehyde resins, melamine-formaldehyde resins, polyamides, polysulfides, amidoamines, and aromatic amines. Assuming that the total weight of the prepared starting resin mixture is 100 phr, the content of hardening agent preferably ranges between 1-30 phr. According to this invention, the aforesaid catalyst may be amines, imidazoles, or BF3-MEA ranging between 0.1-10.0 phr on a scale of total resin weight of 100 phr.

Furthermore, depending on the requirements and purposes of use, other additives such as rheological agents, thixotropic reagent, fumed silica, defoamers, leveling agents, organic solvents, pigments, fire retardants and inorganic fillers may be added.

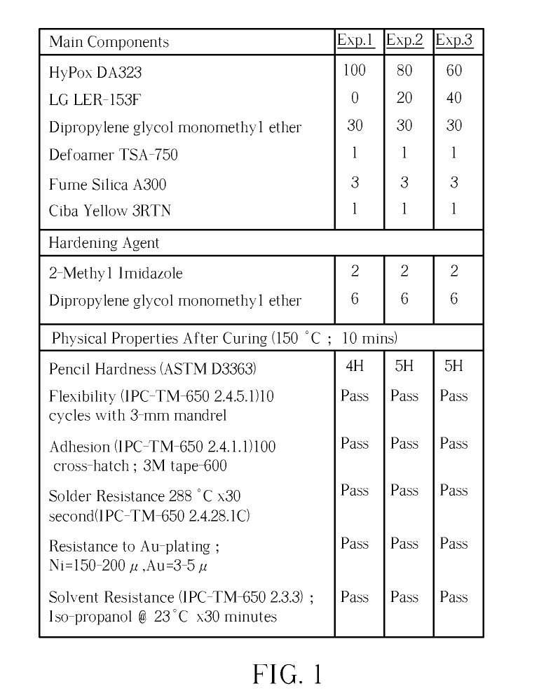

FIG. 1 lists the experiment results (Exp. 1˜Exp. 3) based on dimmer acid modified epoxy resin having different compositions. The compositions listed are preferably used as a thermosetting solder mask for flexible PCB. The main components of the resin composition include HyPox DA 323, LG LER-153F, dipropylene glycol monomethyl ether, defoamer TSA-750, fume silica A300, ciba yellow 3RTN. The hardening agent includes 2-methyl imidazole and dipropylene glycol monomethyl ether. Physical property test results including pencil hardness, flexibility, adhesion, solder resistance, resistance to Au plating, and solvent resistance and test methods thereof are also listed.

In the three experiments (Exp. 1˜Exp. 3), the weight of LG LER-153F (brominated epoxy resin) increases while the weight of HyPox DA 323 decreases. When the dimer acid adducted bisphenol-A resin (HyPox DA 323) is employed singly and does not combine with other types of additive resins such as LG LER-153F as in the Exp. 1 case, it is softer. However, the surface of the resin film is prone to scratching due to reduced hardness. Properly adding other harder epoxy resins such as brominated epoxy resins, bisphenol-A or bisphenol-F series resins can obtain a balance in physical properties.

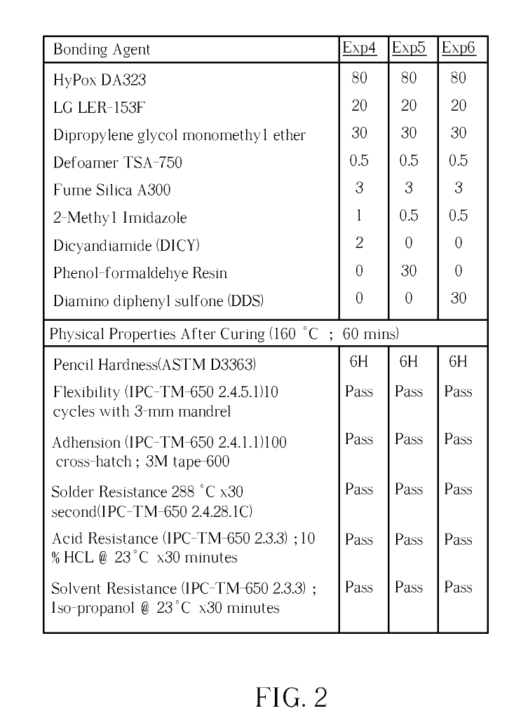

FIG. 2 lists the experiment results (Exp. 4˜Exp. 6) based on dimmer acid modified epoxy resin having different compositions (mainly different hardening agents). The compositions listed are preferably used as a bonding agent for flexible PCB. The common components of the three resin compositions used in Exp. 4˜Exp. 6 respectively include HyPox DA 323, LG LER-153F, dipropylene glycol monomethyl ether, defoamer TSA-750, fume silica A300, and 2-methyl imidazole. The resin composition in Exp. 4 further includes a hardening agent: dicyandiamide (DICY). The resin composition in Exp. 5 further includes a hardening agent: phenol-formaldehye resin. The resin composition in Exp. 6 further includes a hardening agent: diamino diphenyl sulfone (DDS). Physical property test results including pencil hardness, flexibility, adhesion, solder resistance, acid resistance, and solvent resistance and test methods thereof are also listed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermosetting epoxy resin composition with improved flexibility, adhesion and solder resistance, comprising:
(a) 40-100 phr (parts per hundred parts) of dimmer acid modified epoxy resin;
(b) 0-60 phr of an additive epoxy resin for adjusting softness;
(c) 1-30 phr of a hardening agent; and
(d) 0.1-10 phr of a catalyst.

2. The thermosetting epoxy resin composition according to claim 1 wherein the dimmer acid modified epoxy resin comprises Dimer Acid modified DGEBA, Dimer Acid Adducted to an Epoxidized Bisphenol A Resin, and Dimer Acid Glycidyl Ester.

3. The thermosetting epoxy resin composition according to claim 1 wherein the additive epoxy resin comprises Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber.

4. The thermosetting epoxy resin composition according to claim 1 wherein the hardening agent comprises dicyandiamide, phenol-formaldehyde resins, melamine-formaldehyde resins, polyamides, polysulfides, amidoamines, and aromatic amines.

5. The thermosetting epoxy resin composition according to claim 1 wherein the catalyst comprises amines, imidazoles, and BF3-MEA.

6. The thermosetting epoxy resin composition according to claim 1 further comprises rheological agents or thixotropic reagent.

7. The thermosetting epoxy resin composition according to claim 1 further comprises fumed silica.

8. The thermosetting epoxy resin composition according to claim 1 further comprises defoamers.

9. The thermosetting epoxy resin composition according to claim 1 further comprises leveling agents.

10. The thermosetting epoxy resin composition according to claim 1 further comprises organic solvents.

11. The thermosetting epoxy resin composition according to claim 1 further comprises pigments.

12. The thermosetting epoxy resin composition according to claim 1 further comprises fire retardants.

13. The thermosetting epoxy resin composition according to claim 1 further comprises inorganic filler.

14. A flexible printed circuit board (PCB) substrate, comprising:
a copper foil;
a polyimide layer laminated on the copper foil; and
a bonding agent between the polyimide layer and the copper foil, the bonding agent consisting of the components recited in claim 1.
